(19) United States
(12) Patent Application Publication
(10) Pub. No.: US 2017/0154709 A1
(43) Pub. Date: Jun. 1, 2017

(54) ELECTRIC WIRE SHEATHING MEMBER AND WIRE HARNESS

(71) Applicant: Sumitomo Wiring Systems, Ltd., Yokkaichi (JP)

(72) Inventor: Ryo KUROISHI, Yokkaichi (JP)

(21) Appl. No.: 15/358,881

(22) Filed: Nov. 22, 2016

(30) Foreign Application Priority Data
Nov. 27, 2015 (JP) 2015231255

(51) Int. Cl. H01B 7/17; H01B 7/00

(52) U.S. Cl. CPC H01B 7/17; H01B 7/0045

(57) ABSTRACT

An electric wire sheathing member including a resin pipe that can be easily attached to a vehicle, and a wire harness are provided. The electric wire sheathing member includes a resin pipe, the resin pipe including a straight tube portion that has a tubular shape into which an electric wire can be inserted and whose cross-sectional shape is constant in an axial direction, a bellows portion that has a tubular shape into which the electric wire can be inserted and in which ridge portions and valley portions are repeated in an axial direction, and a bent portion that is formed by bending the straight tube portion into a predetermined shape. With this configuration, the straight tube portion is not flexible like a corrugated tube having a bellows shape is, and therefore, the shape of the bent portion is retained. Accordingly, the wire harness can be easily attached to a vehicle.

This application claims the benefit of Japanese Application No. JP2015-231255, filed on Nov. 27, 2015, the contents of which are hereby incorporated by reference in their entirety.

### FIELD

The present invention relates to an electric wire sheathing member and a wire harness.

### BACKGROUND

Conventionally, it has been known that electric wires included in wire harnesses to be arranged underneath the floor of a vehicle and the like are inserted into electric wire sheathing members having a tubular shape so as to be protected. For example, in the wire harness disclosed in JP 2004-171952A mentioned below, a metal pipe is used as the electric wire sheathing member so as to also hold the wiring path of electric wires. The metal pipe is bent into a predetermined shape using a pipe bender.

Wire harnesses using a resin pipe instead of the above-mentioned metal pipe to enable the weight of a vehicle to be reduced have been known. For example, a wire harness disclosed in JP 2009-143326A is obtained by covering the entire length of an electric wire with a hard resin pipe including a straight tube portion and a bellows portion that have been integrally molded. The wire harness is attached to the vehicle by fixing a plurality of portions of the pipe to the body of the vehicle using fixtures.

However, in the wire harness obtained by covering an electric wire with a hard resin pipe including a straight tube portion and a bellows portion that have been integrally molded as mentioned above, the bellows portion is flexible, and thus unpredictable deformation of the wire harness that starts at the bellows portion is likely to occur when the wire harness is attached to the vehicle. Therefore, there has been a problem in that it is difficult to attach the wire harness to the vehicle while retaining the shape of the wire harness.

The present design was made based on the foregoing circumstances, and it is an object thereof to provide an electric wire sheathing member including a resin pipe that can be easily attached to a vehicle, and a wire harness.

### SUMMARY

An electric wire sheathing member according to the present design includes a resin pipe, the resin pipe including a straight tube portion that has a tubular shape into which an electric wire can be inserted and whose cross-sectional shape is constant in an axial direction, a bellows portion that has a tubular shape into which the electric wire can be inserted and in which ridge portions and valley portions are repeated in an axial direction, and a bent portion that is formed by bending the straight tube portion into a predetermined shape.

A wire harness according to the present design includes the aforementioned electric wire sheathing member.

With the present design, the straight tube portion is not flexible like the bellows portion is, and therefore, the shape of the bent portion is retained. Accordingly, the wire harness can be easily attached to a vehicle while retaining the shape of the wire harness.

### DRAWINGS

FIG. 1 is a schematic view illustrating a state in which a wire harness including an electric wire sheathing member according to an embodiment is attached to a vehicle;

FIG. 2 is a side view showing the wire harness including the electric wire sheathing member; and

FIG. 3 is a cross-sectional view showing the wire harness including the electric wire sheathing member.

### DESCRIPTION

Hereinafter, preferred embodiments will be described.

In an electric wire sheathing member, the above-mentioned bellows portion may be integrally provided extending from the end portion of the above-mentioned straight tube portion in the axial direction. With this configuration, the bellows portion can be freely bent, thus making it easy to connect the wire harness.

The electric wire sheathing member may also include a braided wire that is formed in a tubular shape using a plurality of metal strands and that covers the above-mentioned electric wire and is arranged inside the above-mentioned resin pipe, or that covers the resin pipe and is arranged outside the resin pipe.

With this configuration, the electric wire is shielded by the braided wire over the entire length. Here, in the case where the portion of the electric wire that is inserted into a metal pipe is shielded by the metal pipe and portions of the electric wire that project from the metal pipe are shielded by the braided wires in a conventional manner, connecting parts for connecting the braided wires to the end portions of the metal pipe are needed. However, with the above-mentioned configuration, there is no need to connect the pipe and the braided wire, thus making it possible to reduce the number of parts.

### EMBODIMENT

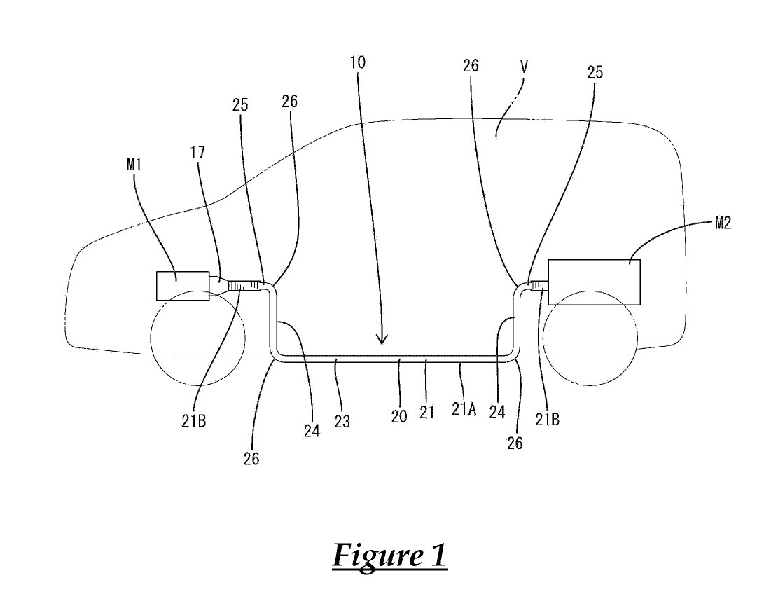

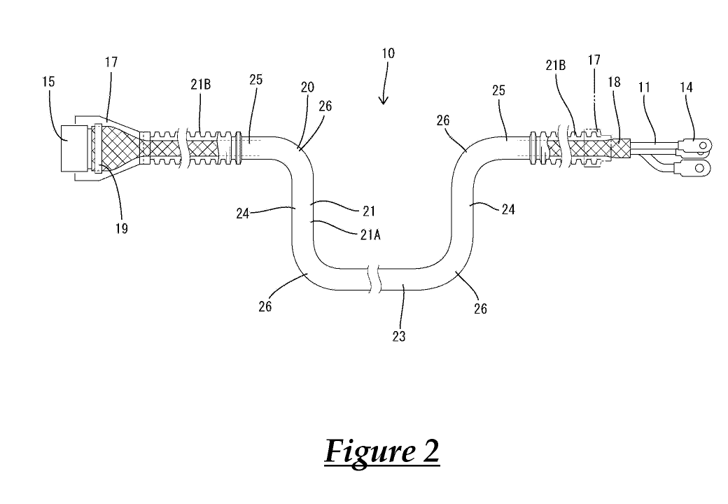

Hereinafter, an embodiment will be described in detail with reference to FIGS. 1 to 3.

A wire harness 10 of this embodiment is to be attached to a vehicle V such as an electric car or a hybrid car. As shown in FIG. 1, the wire harness 10 connects a device M1 arranged in an engine room in the front portion of the vehicle V and a device M2 arranged in a compartment in the rear portion of the vehicle V, and is routed from the front side of the interior of the vehicle V to the rear side of the interior of the vehicle V, passing underneath the floor of the vehicle body, that is, outside the vehicle body frame.

The wire harness 10 includes a plurality of (three in this embodiment) electric wires 11. The electric wires 11 are not provided with a shielding function, and are obtained by covering a conductor 12 with an insulating coating 13. Terminal fittings 14 or a connector 15 that can be connected to the devices M1 and M2 are connected to the end portions of the electric wires 11.

The wire harness 10 includes an electric wire sheathing member 20 for protecting the electric wires 11 that have been inserted into the electric wire sheathing member 20. The electric wire sheathing member 20 covers the electric wires 11 of the wire harness 10 all together.

The electric wire sheathing member 20 includes a resin pipe (referred to as “pipe 21” hereinafter) having a tubular shape into which the electric wires 11 can be inserted. The pipe 21 has an elongated cylindrical shape that has a substantially circular cross section and is open toward the two sides in the axial direction. The thickness dimension (wall thickness dimension in the inside-outside direction) of the pipe 21 is constant over the entire length and the entire circumference.

The pipe 21 includes a straight tube portion 21A having a straight tube shape whose cross-sectional shape is constant (cross-sectional shape does not change) in the axial direction. Most of the pipe 21 (the entire intermediate portion excluding the two end portions) is the straight tube portion 21A.

The straight tube portion 21A is bent into a predetermined shape in order to follow the wiring path of the wire harness 10 in the vehicle V. In this embodiment, most of the straight tube portion 21A is a horizontal portion 23 that is to be substantially horizontally arranged extending underneath the floor of the vehicle V. The two end portions of the straight tube portion 21A are formed into first intersecting portions 24 obtained by bending the straight tube portion 21A in a direction intersecting the horizontal portion 23 and second intersecting portions 25 obtained by bending the straight tube portion 21A in a direction intersecting the first intersecting portions 24. The first intersecting portions 24 are obtained by bending the straight tube portion 21A at a substantially right angle to the horizontal portion 23, and the second intersecting portions 25 are obtained by bending the straight tube portion 21A at a substantially right angle to the first intersecting portions 24. At the two end portions of the straight tube portion 21A, the first intersecting portions 24 are bent in the same direction, and the second intersecting portions 25 are bent in opposite directions. It should be noted that the straight tube portion 21A is also bent in the left-right direction of the vehicle V as appropriate in the state in which the straight tube portion 21A is attached to the vehicle V, although this is not shown in the diagrams.

In the straight tube portion 21A, the portions located between the horizontal portion 23 and the respective first intersecting portions 24, and the portions located between the first intersecting portions 24 and the second intersecting portions 25 are formed into bent portions 26 by bending the straight tube portion 21A. The bent portions 26 are located at four positions in the straight tube portion 21A and each bent at a substantially right angle.

In the state in which the wire harness 10 is attached to the vehicle V, the entirety of the horizontal portion 23 is arranged underneath the floor, and the upper end portions of the first intersecting portions 24 and the entirety of the second intersecting portions 25 are arranged in the interior of the vehicle V. That is, the straight tube portion 21A is arranged extending from the exterior of the vehicle V to the interior thereof. The straight tube portion 21A is fixed to the body of the vehicle V as appropriate using an attachment tool (not shown).

The pipe 21 includes flexible bellows portions 21B that have a bellows shape in which ridge portions and valley portions are repeated in the axial direction. The bellows portions 21B are formed at the two end portions of the pipe 21 and integrally provided extending in the axial direction from the end portions of the straight tube portion 21A. The two ends of the pipe 21 (the ends of the bellows portions 21B) are respectively arranged near the devices M1 and M2. It should be noted that waterproofing parts 17 such as a grommet are provided at the two end portions of the electric wire sheathing member 20 as needed.

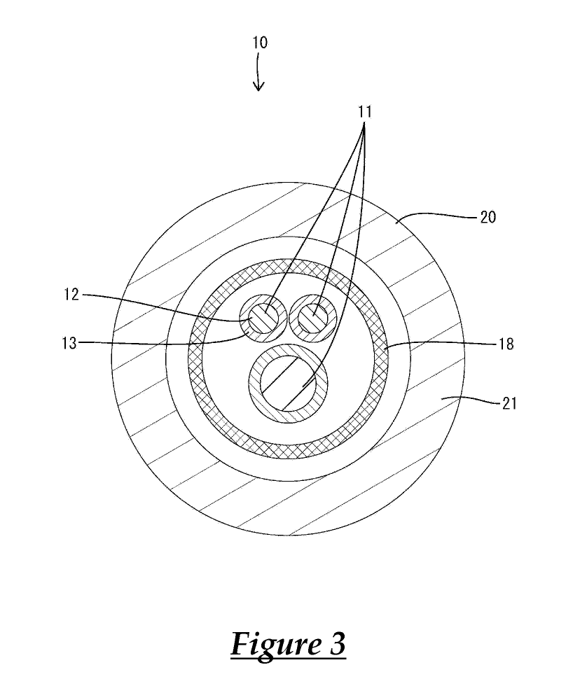

The wire harness 10 includes a braided wire 18 that is formed in a tubular shape using metal strands. The braided wire 18 has flexibility and thus can be freely bent. As shown in FIG. 3, the braided wire 18 covers the three electric wires 11 all together and is arranged inside the pipe 21. The braided wire 18 is long enough to cover the electric wires 11 over the entire length and is arranged extending between the devices M1 and M2. The end portions of the braided wire 18 are connected to the devices M1 and M2 using connecting members 19 such as crimp rings. Thus, the electric wires 11 are shielded over the entire length.

Next, an example of operations for manufacturing the wire harness 10 of this embodiment and an example of operations for attaching the wire harness 10 of this embodiment to a vehicle will be described.

First, the pipe 21 is formed by resin-molding. The manufactured pipe 21 includes the straight tube portion 21A and the bellows portions 21B and has a straight shape as a whole.

Then, the braided wire 18 and the electric wires 11 are inserted into the pipe 21. The end portions of the electric wires 11 and the braided wire 18 project outward from the two end portions of the pipe 21.

Next, the pipe 21 is subjected to bending processing. The straight tube portion 21A of the pipe 21 is bent using a pipe bender so as to have a shape corresponding to the vehicle V. Thus, the bent portions 26 are formed in the straight tube portion 21A of the pipe 21.

Thereafter, the waterproofing parts 17 or the like are connected to the two end portions of the pipe 21 as appropriate.

Accordingly, the operations for manufacturing the wire harness 10 including the electric wire sheathing member 20 are complete.

Next, the manufactured wire harness 10 is attached to the vehicle V.

The straight tube portion 21A of the pipe 21 is fixed to the body of the vehicle V using an attachment tool. Here, if the bellows portion is formed in the electric wire sheathing member, for example, it is difficult to retain the shape of the wire harness. That is, even when a portion having a bellows shape is bent into a predetermined shape in advance, there are cases where the bent shape is not retained and straightens. Therefore, the more the number of bent portions increases, the more difficult it is to retain the shape of the wire harness, and thus it becomes difficult to perform the attachment operations. However, since the bent portions 26 of the electric wire sheathing member 20 of this embodiment are formed in the straight tube portion 21A, which does not have a bellows shape, the bent shape is retained. Accordingly, it is easy to perform the attaching operations.

Then, the terminal fittings 14 or the connector 15 at the end portions of the wire harness 10 are connected to the devices M1 and M2. At this time, since the two end portions of the pipe 21 are the flexible bellows portions 21B, it is easy to connect the wire harness 10 to the devices M1 and M2.

Accordingly, the operations for attaching the wire harness 10 to the vehicle V are complete.

Next, the functions and effects of the embodiment configured as mentioned above will be described.

The electric wire sheathing member 20 of this embodiment includes the resin pipe 21 including the straight tube portion 21A that has a tubular shape into which the electric wires 11 can be inserted and whose cross-sectional shape is constant in the axial direction, and the bent portions 26 that are formed by bending the straight tube portion 21A into a predetermined shape. With this configuration, since the straight tube portion 21A is not flexible like a corrugated tube having a bellows shape is, the shape of the bent portions 26 is retained. Therefore, it is easy to attach the wire harness 10 to the vehicle V. In addition, since the resin pipe 21 is used instead of a metal pipe, there is no need to provide parts such as a pipe end holder for preventing the electric wires 11 from being damaged due to contact with the end surface of the pipe 21, thus making it possible to reduce the number of parts.

In addition, in the pipe 21, the bellows portions 21B that have a tubular shape into which the electric wires 11 can be inserted and that have a bellows shape in which ridge portions and valley portions are repeated in the axial direction are integrally provided extending in the axial direction from the end portions of the straight tube portion 21A. With this configuration, it is easy to connect the wire harness 10 by freely bending the bellows portions 21B. Moreover, the bellows portions 21B are formed integrally with the straight tube portion 21A, thus making it possible to reduce the number of parts compared with the case where the bellows portions and the straight tube portion are separately formed and waterproofing parts or the like are required for connection portions where the bellow portion and the straight tube portion are connected, for example. Furthermore, since the bellows portions 21B are formed, it is possible to prevent the application of load to the straight tube portion 21A of the resin pipe 21 when the vehicle vibrates after the wire harness 10 is attached to the vehicle.

In addition, the wire harness 10 includes the braided wire 18 that is formed in a tubular shape using a plurality of metal strands and that covers the electric wires 11 and is arranged inside the resin pipe 21. With this configuration, the electric wires 11 are shielded by the braided wire 18 over the entire length. Here, in the case where portions of electric wires that are inserted into a metal pipe are shielded by the metal pipe and portions of the electric wires that project from the metal pipe are shielded by braided wires in a conventional manner, connecting parts for connecting the braided wires to the end portions of the metal pipe are needed. However, with the above-mentioned configuration, there is no need to connect the pipe 21 and the braided wire 18, thus making it possible to reduce the number of parts. Furthermore, since the braided wire 18 is arranged inside the pipe 21, the need for a protecting part (part that covers the outside of the braided wire 18) for protecting the braided wire 18 can be eliminated.

### OTHER EMBODIMENTS

The present invention is not limited to the embodiment above, which has been described using the foregoing descriptions and the drawings, and, for example, embodiments as described below are also encompassed within the technical scope of the present invention.

Although the wire harness 10 includes the braided wire 18 in the above embodiment, the braided wire is not necessarily required to be provided.

Although the braided wire 18 is arranged inside the pipe 21 in the above embodiment, there is no limitation to this, and the braided wire may be arranged outside the pipe.

Although the electric wires 11 having no shielding function are inserted into the pipe 21 in the above embodiment, there is no limitation to this, and electric wires having a shielding function may be inserted therein.

Although the braided wire 18 covers all the electric wires 11 together inside the pipe 21 in the above embodiment, there is no limitation to this, and the braided wire may cover only some of the electric wires inside the pipe.

Although a specific example of the shape of the pipe 21 is shown in the above embodiment, there is no limitation to this, and the shape of the pipe (the bent positions of the pipe, the number of bent positions, the bending angles in the bellows portions, and the like) can be changed as desired.

Although the bellows portions 21B are provided at the two end portions of the pipe 21 in the above embodiment, there is no limitation to this, and the bellows portion may be provided at only one of the two end portions of the pipe.

Although the bellows portions 21B are provided at only the two end portions of the pipe 21 in the above embodiment, there is no limitation to this, and the bellows portion may also be formed in the intermediate portion of the pipe, for example.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. An electric wire sheathing member comprising a resin pipe, the resin pipe including:
a straight tube portion that has a tubular shape into which an electric wire can be inserted and whose cross-sectional shape is constant in an axial direction;
a bellows portion that has a tubular shape into which the electric wire can be inserted and in which ridge portions and valley portions are repeated in an axial direction; and
a bent portion that is formed by bending the straight tube portion into a predetermined shape.

2. The electric wire sheathing member according to claim 1, wherein the bellows portion is integrally provided extending from an end portion of the straight tube portion in the axial direction.

3. The electric wire sheathing member according to claim 1, further comprising a braided wire that is formed in a tubular shape using a plurality of metal strands and that covers the electric wire and is arranged inside the resin pipe, or that covers the resin pipe and is arranged outside the resin pipe.

4. A wire harness comprising the electric wire sheathing member according to claim 1.

5. A wire harness comprising the electric wire sheathing member according to claim 2.

6. A wire harness comprising the electric wire sheathing member according to claim 3.
